(19) United States
(12) Patent Application Publication
(10) Pub. No.: US 2016/0142359 A1
(43) Pub. Date: May 19, 2016

(54) ITEM IMPORTANCE INDICATION

(71) Applicant: CITRIX SYSTEMS, INC., Fort Lauderdale, FL (US)

(72) Inventors: Anne Marie Lock, Brooklyn, NY (US); Elizabeth Thapliyal, Santa Barbara, CA (US); Ryan W. Kasper, Santa Barbara, CA (US); Ashish V. Thapliyal, Santa Barbara, CA (US); Nikolay Avrionov, Santa Barbara, CA (US); Ankit Mandhani, San Francisco, CA (US); Yogeshwar Narayana Shenoy, Bangalore (IN); Stefan Alexander von Imhof, Santa Barbara, CA (US)

(21) Appl. No.: 14/543,235

(22) Filed: Nov. 17, 2014

(51) Int. Cl. H04L 12/58

(52) U.S. Cl. CPC H04L 51/24; H04L 51/22

(57) ABSTRACT

A method of operating a computerized device to indicate importance of messages to a user includes calculating importance scores for the messages based on importance features of the messages, the importance scores calculated as weighted sums of respective feature scores for the messages, and selecting messages for including in a subset of messages based on the importance scores. Message data and respective importance indicators for the subset of messages are displayed to the user, the importance indicators drawn from a set of distinct importance indicators corresponding to the set of importance features. An importance indicator is displayed for a given importance feature of a message when a feature score for the importance feature is above a threshold.

### BACKGROUND

The disclosure is related to the field of electronic mail (email) or similar messaging systems.

In existing email systems it is known to employ a graphical user interface (GUI) to present a user with information about email messages received, sent, and stored by the email system. One common organization employs a folder paradigm for organizing and presenting lists of emails, including for example an “Inbox” folder for emails that have recently been received and may not have been read yet. Emails may be listed by contents of fields such as date, sender, etc.

### SUMMARY

One of the problems in the use of email systems can be referred to as “email overload”, i.e., a user regularly receiving a large number of emails from different senders on different topics. Email overload leads to users missing important emails or spending a lot of time dealing with their email. In the latter case the user's efficiency may be adversely affected; in the former the user's effectiveness may be. It would be desirable for the email system to better help users who face email overload to avoid missing important emails without having to spend a lot of time monitoring, reviewing and managing their emails. Such an improved email system would be especially useful in supporting the use of mobile devices, where both user time and display screen space are limited.

In one aspect, a method is disclosed of operating a computer executing a messaging application to indicate importance of messages to a user. The method includes calculating respective importance scores for the messages based on a predetermined set of importance features of the messages, with the importance scores being calculated as weighted sums of respective feature scores for the messages across the set of importance features. Messages are then selected for including in a subset of messages based on the importance scores. Message data and respective importance indicators are displayed for the subset of messages to the user, with the importance indicators being drawn from a set of distinct importance indicators corresponding to the set of importance features. An importance indicator is displayed for a given importance feature of a given message when a feature score for the given importance feature is above a predetermined threshold.

The importance features can include things like the identification of certain senders in the emails, for example senders whose emails are typically replied to more promptly by the user than emails from other senders; whether an email is a reply to an earlier message sent by the user; whether an email includes text or other data identifying a request to be responded to or a task assigned to the user; etc. The importance indicators may be small graphical symbols displayed alongside metadata and other information identifying the messages, such as date, sender, subject, etc. A user can scan the importance indicators to quickly identify more important emails.

In another aspect, a method is disclosed of operating a computer executing a messaging application to provide importance information to a user. This method includes analyzing contents of a message by (i) calculating respective importance scores for respective portions of the message, the importance scores being calculated based on one or more predetermined importance criteria, and (ii) selecting one or more highest-scored portions. The analysis may be lexical and statistical in nature, i.e., assessing importance based on presence of statistically uncommon words. Metadata and selected content of the message are displayed to the user, where the metadata is obtained from a structured field of the message and identifies the message to the user, and the selected content includes the highest-scored portions presented in a manner identifying the highest-scored portions as the importance information for the message. As an example, the message may include a particular sentence deemed most important because of its use of relatively uncommon words. The whole or a part of the message text is displayed, and the important sentence is highlighted in some manner (bolding, underlining, etc.) to identify it as the importance information.

The disclosed techniques address the problem of email overload by enabling users to quickly determine how important emails are, without having to open and read through the emails, and to quickly see the most important portions. The user can more efficiently organize their email viewing without missing important emails, and can quickly obtain the core importance of an email without having to read through it in its entirety. User efficiency and effectiveness can be improved accordingly.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a computerized device such as a personal computer or smartphone;

FIG. 2 is a block diagram of software-implemented functional components of a computerized device;

FIG. 3 is a screen of a graphical user display (GUI);

FIG. 4 is a flow diagram of operation of a computerized device;

FIG. 5 is a screen of a GUI;

FIG. 6 is a flow diagram of operation of a computerized device;

FIG. 7 is a screen of a GUI.

### DETAILED DESCRIPTION

FIG. 1 shows a configuration of computerized device 10. The hardware includes one or more processors 12, memory 14, and interface circuitry 16 interconnected by data interconnections 18 such as one or more high-speed data buses. The interface circuitry 16 provides a hardware connection to an external network, a user interface display, and other input/output (I/O) devices. As shown, the memory 14 stores an operating system (O/S) 20 and an application program referred to as a “mail client” (MAIL CLT) 22 that interacts with a separate mail server. The processor(s) 12 with connected memory 14 may also be referred to as “processing circuitry” herein. There may also be local storage 24 such as a local-attached disk drive or Flash drive. In operation, the processor(s) 40 execute computer program instructions of the O/S 20 and mail client 22 to cause the hardware to function in a software-defined manner. Thus the computer hardware executing instructions of the mail client application 22, for example, can be referred to as a mail client circuit or mail client component, and it will be understood that a collection of such circuits or components can all be realized and interact with each other as one or more sets of computer processing hardware executing different computer programs as generally known in the art. Further, the application software may be stored on a non-transitory computer-readable medium such as an optical or magnetic disk, Flash memory or other non-volatile semiconductor memory, etc., from which it is retrieved for execution by the processing circuitry, as also generally known in the art.

The computerized device 10 of FIG. 1 may be realized in any of a number of commercial forms, including for example a conventional desktop computer, a portable computer, and a smaller portable device such as a smartphone. In conventional desktop and portable computer environments, the mail client 22 may be a so-called “fat” application, i.e., one that is installed on the user device, contains all the required data and program elements (e.g., as libraries), and is executed completely locally on a user device. However, it will be appreciated that the disclosed techniques may also be realized by other forms of implementation. In particular, the techniques may also be used in so-called thin-client or Web access environments in which many functions are performed by memory-resident applets in the context of a browser application executed on a user device, with separate server code being executed at a separate webmail server.

Even more generally, the disclosed techniques are not necessarily limited to electronic mail. Email importance indication such as described herein may be used in other applications requiring efficient user organization and handling of a large number of messages such as emails.

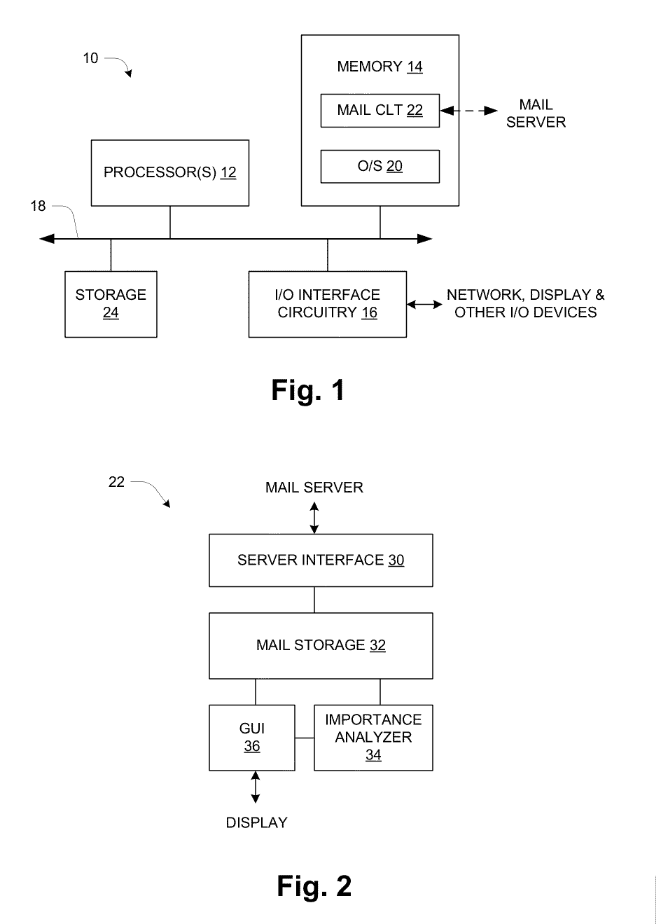

FIG. 2 shows the organization of the mail client 22. Major components include a server interface 30, mail storage 32, an importance analyzer 34 and a graphical user interface (GUI) 36. As generally known in the art, the mail client 22 communicates with the remote mail server using a mail delivery protocol such as Post Office Protocol (POP), Internet Message Access Protocol (IMAP), etc. to send and receive emails. Received emails, and generally sent emails as well, are stored in the mail storage 32, which may be realized for example as a large, locally stored mail file such as known in the art. Both the importance analyzer 34 and GUI 36 operate upon emails that are stored in the mail storage 32. The GUI 36 provides conventional functions such as viewing contents of the mail storage 32 (e.g. using a folder type of paradigm as generally known), reading emails, and composing and sending new emails. As described more particularly below, the importance analyzer 34 provides functions for presenting emails in a way that can improve efficiency and effectiveness of the email user.

More particularly, and as described more below, the importance analyzer 34 provides users visual indicators about why emails are important, so a user can deal with them appropriately. Further, it shows the users summaries and/or highlights of collections of emails such as threads, folders, labels, etc., so users can deal with emails in a useful context. Also, in some embodiments a user can click/tap on a highlight/summary of an email and quickly create a task from it.

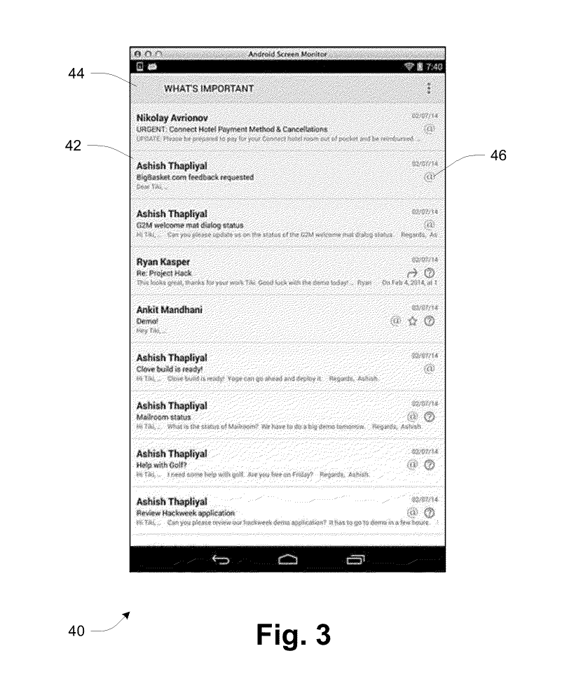

FIG. 3 is an example display screen 40. It includes a listing of emails or messages 42. These may be grouped by relative importance for display purposes, such as by use of a logical folder or a user-activated control by which the user requests an importance-based display. In this case the screen 40 has an explicit heading 44 (“What's Important”) identifying that this is an importance-based display as distinct from some other predefined or user-defined display such as by date, folder, etc.

The display for each email 42 includes one or more pieces of metadata that identify the email 42 as an item apart from its content (e.g., sender name and date, as shown), a content snippet which is the more important sentence/phrase, and one or more importance indicators 46 that convey information about the importance of the email to the user. The metadata and selected content may be referred to as “message data” as distinct from the importance indicators 46. A variety of types of importance indicators 46 may be used, each being associated with a respective feature or category of importance criteria. As an illustrative example, the following importance indicators and features/categories may be used:

| Importance Indicator | Importance Feature/category |
|---|---|
| @ (at symbol) | User is mentioned in the email |
| * (star or asterisk symbol) | Sender is important, e.g., someone the user |
| | replies to very frequently and/or quickly |
| ┌ (reply symbol) | The email is a reply to a question/inquiry |
| | sent by the user in an earlier email |
| ? (question symbol) | The email contains a question or task for the |
| | user |

The use of importance indicators and the most important content from the email helps the user decide at a glance how to deal with the email.

In operation, the importance analyzer 34 performs an importance determination algorithm to score emails/items based on a predetermined set of importance features, and uses the scores to control how the emails/items are displayed by the GUI 36. The following is an example set of importance features:
i) Email contains user's name/nickname
ii) Email is addressed to the user (and/or a few others)
iii) User usually opens the sender's email quickly
iv) User usually replies to the sender of the email quickly
v) Email contains a task for the receiver
vi) Email is a reply to an email previously sent by the user
vii) Email has urgent time signifier such as ASAP, EOD today, etc.
viii) Email is a calendar invite

For each feature, a feature score is calculated, based on the presence of the feature and a respective weight. The overall importance score is the sum of all the weighted feature scores. If a feature score is above a threshold, the email is said to be important because of that particular feature, and thus it is an importance reason for that email. An email may have multiple importance reasons. Importance reasons are indicated in the display by appropriate importance indicators, signaling to the user why the given email is important so the user can quickly understand the importance context of the email and take appropriate action. In one embodiment the importance indicators may include special symbols or icons such as the indicators 46 shown in FIG. 3. Alternatively they may include distinct coloring or other treatment of other information displayed for the email. For example, if an email is important because of its sender, the sender's name can be bolded, colored or otherwise highlighted.

The importance analysis may be adaptive based on user behavior. The importance determination algorithm may start out with an initial weighing of the various importance features. The algorithm can then adjust these weights based on inferred importance as deduced by watching the user's actions such as opening emails, replying to them, searching for them, etc. Thus the algorithm becomes customized to the user. As an example, if the user always reads and replies quickly to the emails from a particular sender (e.g., a superior or a client/customer), the algorithm can determine that the sender is important and operate accordingly, i.e., ensure that emails from that sender are marked/organized as important and that an appropriate graphical importance indication is made (e.g., using an asterisk and/or bolding/coloring as described above).

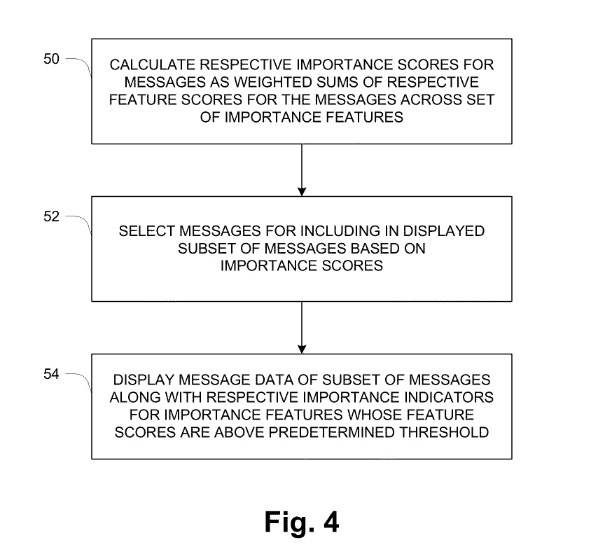

FIG. 4 is a high-level flow diagram of operation of a computerized device as it pertains to using importance indicators to provide graphical indication of importance of a set of messages to a user. At 50, respective importance scores are calculated for the messages based on a predetermined set of importance features, with the importance scores being calculated as weighted sums of respective feature scores for the messages across the set of importance features. Example features includes those mentioned above, i.e., whether the user is mentioned in a message, whether it includes a question or task for the user, etc. At 52, messages are selected for including in the set of messages displayed to the user based on the importance scores. At 54, message data of the set of messages is displayed to the user along with respective importance indicators for the displayed messages. Here “message data” refers to metadata that identifies the message as an item, distinct from the message content. Example metadata includes the sender name, date of message, etc. The importance indicators are drawn from a set of distinct importance indicators corresponding to the importance features, such as the example set described above. An importance indicator is displayed for a given importance feature of a given message when a feature score for the importance feature for that message is above a predetermined threshold.

Below is a specific example of a method of importance calculation. This method uses the following weights:
1. QUESTION_WEIGHT=100
2. MAX_FREQUENT_WEIGHT=100
3. REPLY_ONLY_TO_ME=100
4. SENT_ONLY_TO_ME=65
5. ME_IN_LIST=35

The algorithm periodically assigns importance scores to the set of unread messages. An importance score is derived as follows:
Importance Score=QUESTION_WEIGHT*(isQuestion)+REPLY_ONLY_TO_ME*(isReplyOnlyToMe)+SENT_ONLY_TO_ME*(isSentOnlyToMe)+ME_IN_LIST*(amIinTheToList)+MAX_OVER_QUESTIONS_IN_EMAIL(TimeWt(Question))+MAX_FREQUENT_WEIGHT*(howFrequentlylReplyToThisSender/MaxReplyFrequencyToAllSenders)
TimeWt(Question)→question converted to lowercase contains
   “asap”→return 100, else
   “today”→return 90, else
   “tomorrow”→return 60, else
   “this week:→return 50.

Another way to indicate importance of a message or similar item to a user is to automatically identify an important part of a message and highlight it or use it to summarize the message. Such highlighting or summarizing helps users quickly see the most important parts of an individual email or a collection such as a thread, sub-topic or topic.

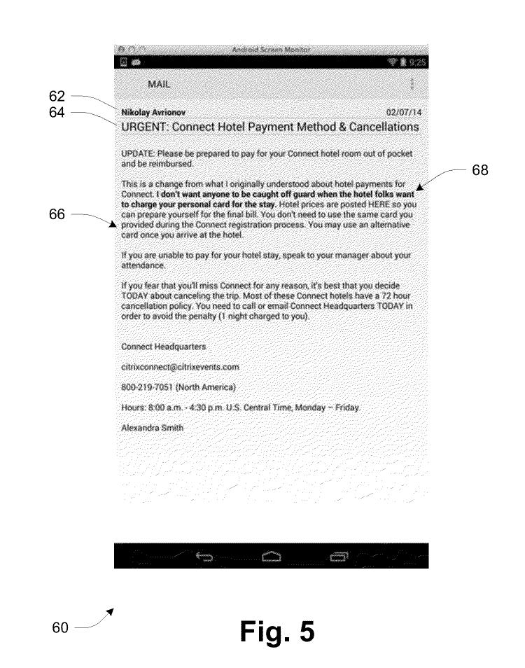

FIG. 5 is an example display screen 60. In this example, a message is displayed in a usual manner including metadata 62 at the top (e.g., sender name and date), subject line 64, and body text 66. An analysis has been performed and has identified a specific portion 68 of the body text 66 as most important, and this portion 68 is displayed with bolding or similar highlighting to provide visual emphasis. In this case the message notifies the recipient that the arrangements for paying for a hotel room have changed. The importance analyzer 34 has applied an analysis of the type described below to identify one of the sentences as most important, and this sentence is highlighted as the important portion 68.

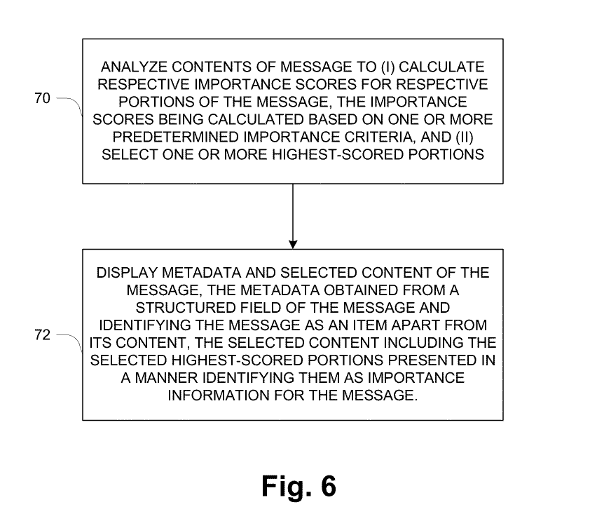

FIG. 6 is a high-level flow diagram of the method which provides message importance information to a user in the form or highlighting or summary. At 70, the contents of a message are analyzed to (i) calculate respective importance scores for respective portions of the message, the importance scores being calculated based on one or more predetermined importance criteria, and (ii) select one or more highest-scored portions. Various specifics are described below. In one embodiment, the unit of analysis is a sentence, i.e., each sentence is assigned a respective importance score and one or more sentences are selected as the highest-scoring portions. At 72, metadata and selected content of the message is displayed to the user. The metadata is obtained from a structured field of the message and identifies the message as an item apart from its content, i.e., a sender name, date, etc. The selected content that is displayed includes the selected highest-scored portions presented in a manner identifying them as the importance information for the message. Examples include bolding as shown in FIG. 5. Other manners of display are of course possible.

Although FIG. 6 illustrates highlighting for a single email, the technique can be used more broadly as follows:

a) Email Highlight: Showing the most important sentence or two from an email so users can quickly get to the important information in the email.

b) Email Thread Highlight: Showing the most important few sentences among a collection of emails in an email thread. Alternatively, showing the most important sentence in each email of a thread.

c) Email Subtopic Highlight: Showing the most important few sentences among a collection of emails in an email subtopic. Alternatively, showing the most important sentence for each email in an email sub-topic.

d) Email Topic Highlight: Showing the most important few sentences among a collection of emails in an email topic. Alternatively, showing the most important sentence for each sub-topic in the topic.

In one embodiment, the following analysis may be used for the analysis step 70 of FIG. 6:

1. Remove all duplicated or standard content in the emails (such as included replies, forwards, signatures, etc.), to arrive at the core content of the email.

2. Use a summarization algorithm to generate a summary. Known summarization algorithms include Sentence Extraction, LexRank, and TextRank. Another option is a more custom summarization algorithm such as the following:
a. Split the core email content into sentences.
b. Calculate the frequencies of the uncommon words (ignore common or noise words such as articles, conjunctions etc.)
c. For each sentence, sum the frequencies of the uncommon words to generate a sentence importance score.
d. Select the sentence with the highest importance score.

3. Collections of emails such as threads, topics and sub-topics can be handled in one of a variety of ways. For example, a summary can be showed for each item within the collection, or alternatively a multi-document summarization algorithm such as Grasshopper can be used.

4. More recent emails may be weighted higher to give more importance to fresh information. This can be done by choosing larger summaries from recent emails and smaller summaries from older emails. The parameters of the summarization algorithms may be modified to give smaller weights to older emails.

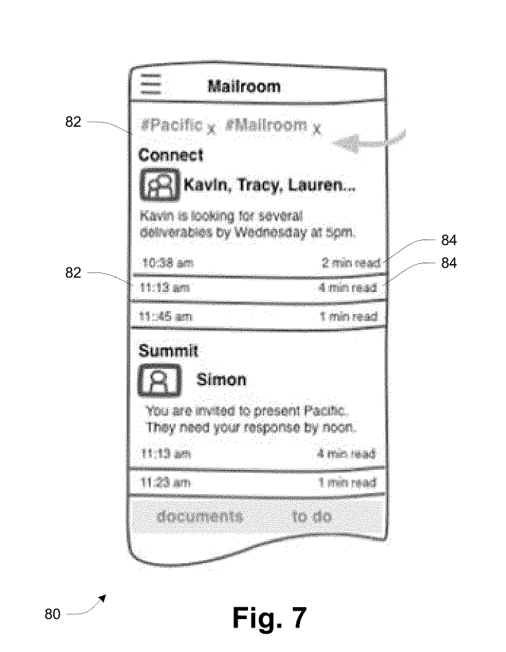

FIG. 7 is a display screen 80 illustrating another feature that can help a user to efficiently manage his/her use of email. A listing of emails 82 is presented along with respective time-to-read values 84 indicating approximately how much time is required to read the emails 82. This information can enable a user to decide whether/when to read one or more emails based on the time available to the user and the time-to-read values 84. Thus if a message is long and is estimated to require 5 minutes to read, but the user is only doing a quick check of messages and cannot devote that much attention, the user can easily skip over the 5-minute message without having to take the time to open the message, begin reading it, and conclude that he/she will not be able to adequately digest it at the present moment. Known time-to-read and other document complexity algorithms can be employed.

While various embodiments of the invention have been particularly shown and described, it will be understood by those skilled in the art that various changes in form and details may be made therein without departing from the spirit and scope of the invention as defined by the appended claims.

What is claimed is:

1. A method of operating a computer executing a messaging application to indicate importance of messages to a user, comprising:
calculating respective importance scores for the messages based on a predetermined set of importance features of the messages, the importance scores calculated as weighted sums of respective feature scores for the messages across the set of importance features;
selecting messages for including in a subset of messages based on the importance scores; and
displaying message data and respective importance indicators for the subset of messages to the user, the importance indicators drawn from a set of distinct importance indicators corresponding to the set of importance features, an importance indicator being displayed for a given importance feature of a given message when a feature score for the given importance feature is above a predetermined threshold.

2. A method according to claim 1, wherein the set of importance features includes one or more features of current contents of the messages independent of past or future messages.

3. A method according to claim 2, wherein the features of current contents of the messages include one or more of (i) having a recipient address matching an address of the user, (ii) containing an appointment or task for the user, or (iii) containing an urgent time signifier.

4. A method according to claim 1, wherein the set of importance features includes one or more features of contents of the messages in relation to past action of the user for previous messages having the same contents;

5. A method according to claim 4, wherein the features of contents of the messages include one or more of (i) a sender address of a sender for which the past action of the user is to open messages from the sender faster than opening messages from other senders; (ii) a sender address of a sender for which the past action of the user is to reply to messages from the sender faster than replying to messages from other senders.

6. A method according to claim 1, wherein the set of importance indicators include one or more of: (i) an at symbol indicating mention of a specific user as a first importance feature; (ii) a star symbol indicating importance of a sender of a message as a second importance feature; (iii) a curved arrow symbol indicating that a message is a reply to an earlier message as a third importance features; and (iv) a question mark indicating that a message contains a question or request as a forth importance feature.

7. A method according to claim 1, wherein the calculating, selecting and displaying are performed in an adaptive manner based on behavior of the user over time, an initial weighting of the importance features being used at an initial time, the weighting being adjusted based on inferred importance as deduced by observing actions of the user including one or more of opening messages, replying to messages, or searching for messages.

8. A method of operating a computer executing a messaging application to provide importance information to a user, comprising:
analyzing contents of a message by (i) calculating respective importance scores for respective portions of the message, the importance scores being calculated based on one or more predetermined importance criteria, and (ii) selecting one or more highest-scored portions; and
displaying metadata and selected content of the message to the user, the metadata obtained from a structured field of the message and identifying the message to the user, the selected content including the highest-scored portions presented in a manner identifying the highest-scored portions as the importance information for the message.

9. A method according to claim 8, wherein the portions are respective groups of words, and wherein calculating respective importance scores for the portions includes summing respective frequencies of use of the words of the groups to generate the respective importance scores.

10. A method according to claim 9, wherein the groups of words are sentences.

11. A method according to claim 8, wherein displaying the selected content includes highlighting the selected content.

12. A method according to claim 11, wherein highlighted selected content is displayed in context in a message with surrounding portions not highlighted.

13. A method according to claim 8, wherein the message is one of a set of related messages having respective metadata displayed along with the metadata and selected content of the message.

14. A method according to claim 8, further including (i) receiving an indication from the user that a task item is to be created based on the selected content of the message, and (ii) in response to the indication, creating the task item including a task description generated based on the selected content.

15. A method according to claim 8, further including (i) calculating a time-to-read value as a measure of time required to read the message based on a length and complexity of the message, and (ii) displaying the time-to-read value along with the metadata and selected content.

16. A method according to claim 8, wherein the analyzing and displaying are repeated for additional messages, and wherein displaying the selected content includes displaying relatively more content of recent ones of the messages than of older ones of the messages.
